(19) United States
(12) Patent Application Publication
(10) Pub. No.: US 2023/0164293 A1
(43) Pub. Date: May 25, 2023

(54) METHOD OF PROVIDING HIGH-DEFINITION PHOTO SERVICE USING VIDEO IMAGE FRAME

(71) Applicant: CUPIX, INC., Gyeonggi-do (KR)

(72) Inventors: SeockHoon BAE, Seoul (KR); Jun Young PARK, Gyeonggi-do (KR); Jin Hwan CHOI, Seoul (KR)

(73) Assignee: CUPIX, INC., Gyeonggi-do (KR)

(21) Appl. No.: 17/988,768

(22) Filed: Nov. 17, 2022

(30) Foreign Application Priority Data
Nov. 19, 2021 (KR) 10-2021-0160222
Feb. 17, 2022 (KR) 10-2022-0020848

(51) Int. Cl. H04N 7/015; G06T 17/00; G06T 7/20; G06V 10/74; G06F 3/14

(52) U.S. Cl. CPC H04N 7/015; G06T 17/00; G06T 7/20; G06V 10/761; G06F 3/14

(57) ABSTRACT

Provided is a method of providing a high-definition photo service using a video image frame, and more particularly, a method of providing a high-definition photo service using a video image frame, according to which a high-definition photo is selectively displayed by using image frames of a filmed video. According to the method of providing a high-definition photo service using a video image frame, not only a large amount of image information may be obtained quickly and effectively by taking a video, but also the technical advantage in definition obtainable by taking a photo may be achieved by separately extracting and using image frames having a definition higher than a certain reference definition, among image frames included in the video.

### CROSS-REFERENCE TO RELATED APPLICATION

This application is based on and claims priority under 35 U.S.C. § 119 to Korean Patent Application No. 10-2021-0160222, filed on Nov. 19, 2021 and 10-2022-0020848 filed on Feb. 17, 2022, in the Korean Intellectual Property Office, the disclosure of which is incorporated by reference herein in its entirety.

### BACKGROUND

### 1. Field

The disclosure relates to a method of providing a high-definition photo service using a video image frame, and more particularly, to a method of providing a high-definition photo service using a video image frame, according to which a high-definition image is selectively displayed by using image frames of a filmed video.

### 2. Description of the Related Art

There have been a wide variety of services using photo images. Photo images are generally taken in a stationary state and thus have a relatively high definition. Various services using such photo images having a relatively high definition may be provided.

For example, by using a photo image and camera intrinsic parameters, such as a relative position between a projection center and a projection plane of a camera used to take the photo image, and a size of a projection plane (complementary metal oxide semiconductor (CMOS) image sensor, charge coupled device (CCD) image sensor, etc.), a position, a direction, and a projection center of each photo image may be calculated. As such, photo images of an object which are taken in different positions or at different angles may be used for various purposes, such as to constitute a three-dimensional (3D) shape of the object, to calculate a size of the object or a distance to the object, or to provide a 360 virtual reality (VR) service.

In such various methods of using photo images, more numbers of photos taken at different angles and positions may facilitate provision of a high-quality service. However, taking a number of photos requires relatively long time and much effort.

As a video is constituted of combined image frames sequentially taken according to time flow, much image information may be obtained in relatively short time.

However, when a user takes a video while moving with a video camera, the definition of image frames of a filmed video may decrease according to a movement speed and a rotation speed, which leads to generation of blurriness in the video. In case of data of a video taken by a moving camera, it is highly likely that the definition of image frames of such video is low. As a low-definition image does not show clear outlines of objects, shapes and outlines of objects shown in the image may not be clearly identified. Moreover, when a taken image including letters has a low definition, it may be difficult to identify the letters included in the image.

FIG. 1 illustrates an example of a low-definition image frame. FIG. 2 illustrates an example of an image frame having a higher definition than the image frame illustrated in FIG. 1. Upon comparing FIG. 1 with FIG. 2, it is understood that the shape of furniture, such as chairs, desks, etc. is more precisely identified, and the pictures hanging on the wall are shown more clearly in the image frame of FIG. 2.

As such, when image frames extracted from data taken in a video format are used, various limitations on specific use of such image frames may arise due to lowered definition as described above.

For example, when a three-dimensional (3D) shape of an object taken by using image frames of a video is extracted, the accuracy of the resultant 3D shape may be deteriorated. In addition, when a distance between two points on the space is calculated by using image frames of a video, the calculation result may not be accurate.

Moreover, when a 360 VR video is implemented by using image frames of a 360° video, and then an area taken in a low definition is displayed on a screen of a display device, specific shapes of a desired object, such as a letter, a form, a structure, a person, etc. may not be easily identified. For example, when a user wishes to check construction progress of a building through a video, it may be difficult to identify whether the main structures are constructed according to drawings because of low definition of image frames.

### SUMMARY

Provided is a method of providing a high-definition photo service using a video image frame, the method capable of overcoming issues caused by a low-definition photo image included in an image frame constituting a video when providing various services by extracting image frames constituting a video.

Additional aspects will be set forth in part in the description which follows and, in part, will be apparent from the description, or may be learned by practice of the presented embodiments of the disclosure.

According to an aspect of the disclosure, a method of providing a high-definition photo service using a video image frame includes (a) receiving and storing, by a video receiver module, a target video taken in video format, (b) obtaining, by a definition acquisition module, a definition for at least some image frames among image frames constituting the target video, (c) storing, by a definition storage module, the definition obtained in (b) to correspond to an image frame, and (d) displaying, by a display module, at least one of selected image frames, which are image frames having the definition stored in (c) that is higher than a reference definition, on a display device.

According to another aspect of the disclosure, a method of providing a high-definition photo service using a video image frame includes (a) receiving and storing, by a video receiver module, a target video taken in video format, (e) generating, by a VR module, a 360 virtual reality (VR) image by using image frames of the target video stored in (a), (b) obtaining, by a definition acquisition module, a definition of the 360 VR image generated by the VR module in (e), (c) storing, by a definition storage module, the definition obtained in (b) to correspond to the 360 VR image, (f) displaying, by a display module, the 360 VR image generated in (e) on a display device, and (d) displaying, by the display module, at least one of selected image frames, which are 360 VR images having the definition stored in (c) that is higher than a reference definition, on the display device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a low-definition image frame;

FIG. 2 illustrates an example of an image frame having a higher definition than the image frame illustrated in FIG. 1;

FIG. 3 is a block diagram of a device configured to implement an example of a method of providing a high-definition photo service using a video image frame according to the disclosure;

FIG. 4 is a flowchart showing an example of a method of providing a high-definition photo service using a video image frame according to the disclosure;

FIG. 5 illustrates an example of a low-definition image frame according to the disclosure; and

FIG. 6 illustrates an example of an image having a higher definition than the image illustrated in FIG. 5 according to the disclosure.

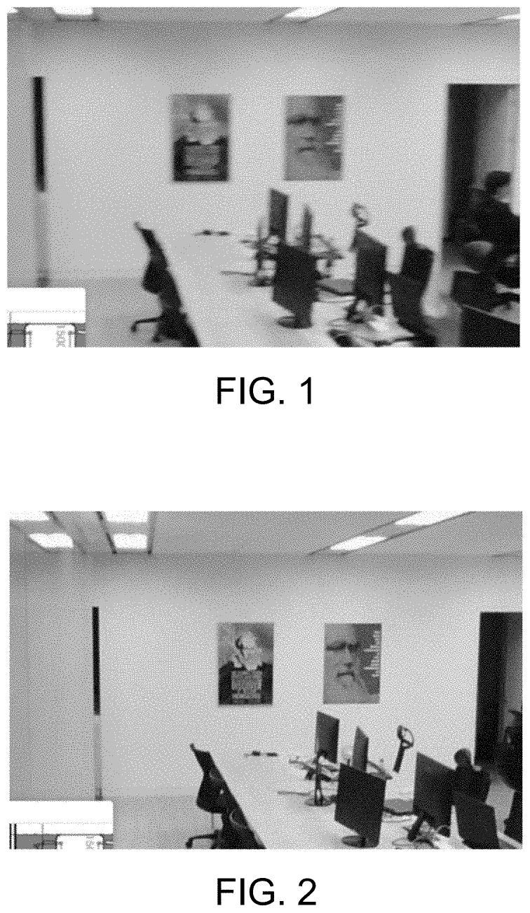

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, a method of providing a high-definition photo service using a video image frame according to an embodiment is described with reference to the accompanying drawings.

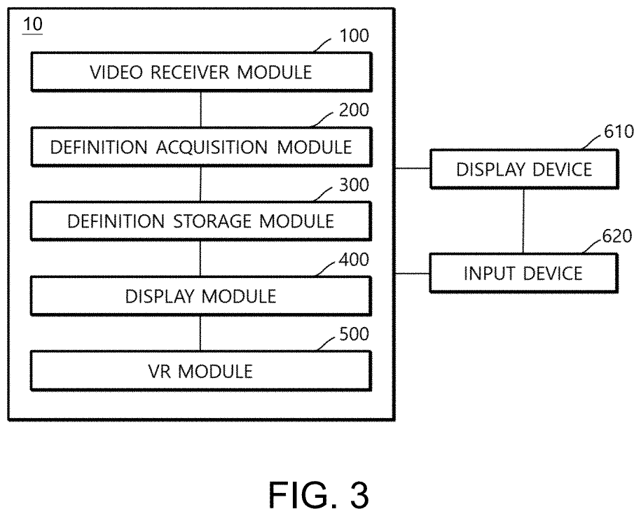

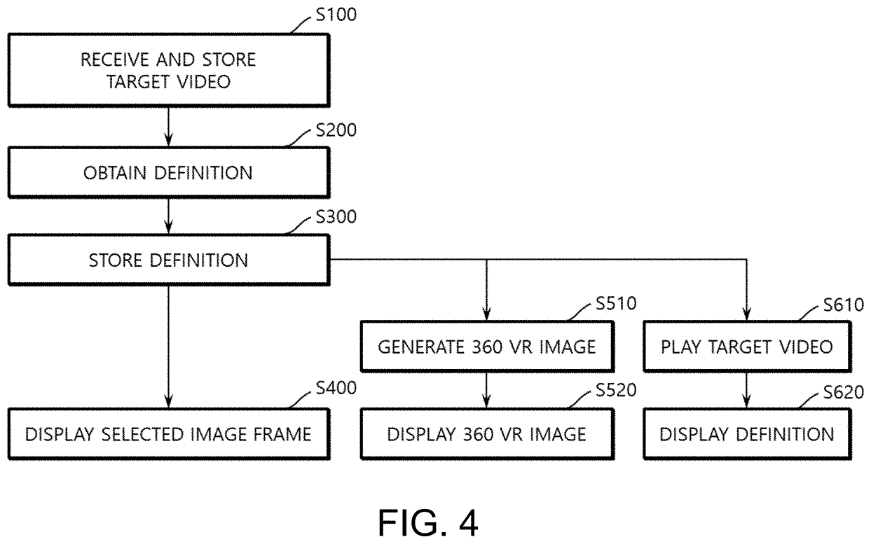

FIG. 3 is a block diagram of a device configured to implement an example of a method of providing a high-definition photo service using a video image frame according to the disclosure, and FIG. 4 is a flowchart showing an example of a method of providing a high-definition photo service using a video image frame according to the disclosure.

With reference to FIG. 3, a device 10 configured to implement a method of providing a high-definition photo service using a video image frame according to the disclosure may include a video receiver module 100, a definition acquisition module 200, a definition storage module 300, and a display module 400. The device 10 may be a computer system, and the modules in the device 10 may be implemented by one or more hardware processors or integrated circuits as known per se.

The video receiver module 100 may receive and store a target video taken in video format. Various types of videos including image frames which may be rendered according to time flow may be used as the target video received by the video receiver module 100. The target video may be a two-dimensional (2D) video taken by a mobile phone or a camcorder, or a video obtained by combining image frames taken in a hemi-sphere shape or in a sphere shape to produce a 360 VR video. The target video may be any type of video data which is taken by using a camera lens and may be sequentially played according to time flow.

The definition acquisition module 200 may obtain a definition of each of image frames constituting the target video received by the video receiver module 100. The definition acquisition module 200 may obtain a definition by receiving a definition of the target video from an external device or by calculating a definition of image frames of the target video. Various methods including publicly known ones may be used as a method of calculating, by the definition acquisition module 200, a definition of image frames of the target video. In some cases, the definition acquisition module 200 may calculate a definition for some image frames selected by various methods, instead of calculating a definition for every image frames of the target video.

The definition storage module 300 may store the definition calculated by the definition acquisition module 200 to correspond to the relevant image frame. That is, the definition storage module 300 may store the definition value calculated by the definition acquisition module 200 in a form in which a definition value may correspond to each image frame of the target video.

The display module 400 may play and display the target video on a display device 610 or display on the display device 610 an image frame having a relatively high definition, of the target video. In some cases, the display module 400 may divide areas of the display device 610 to play the target video and simultaneously display an image frame having a high definition. Moreover, the display module 400 may display a definition of an image frame included in the target video by a quantitative method or a qualitative method on the display device 610 while displaying the target video on a screen.

Hereinafter, how the method of providing a high-definition photo service using a video image frame according to the disclosure is specifically performed by using the device configured as described above is explained with reference to FIG. 4.

First, the video receiver module 100 may receive and store the target video ((a); S100). As described above, various types of videos may be used as the target video according to a purpose and use.

Then, the definition acquisition module 200 may obtain a definition for at least some image frames among image frames constituting the target video ((b); S200). In the embodiment, a definition may be calculated and obtained for every image frames of the target video.

Various methods may be used when the definition acquisition module 200 calculates definitions of the image frames. Although three main methods are described in the embodiment, other methods than the three methods described below may be used to calculate the definition of image frames.

First, the definition acquisition module 200 may compare image frames that are time-sequentially adjacent to each other and determine that an image frame having less changes from adjacent image frames has a higher definition. In such case, the definition acquisition module 200 may compare image frames of the target video which are adjacent to each other in the order of time and determine that an image frame having less changes from adjacent image frames has a higher definition. The degree of definition may be calculated by using the fact that when the target video is taken by a camera which is in a stationary state or moves at a low speed, changes between image frames are reduced, and the definition increases. A method such as an optical flow method may be an example of such method of calculating a definition.

Second, the definition acquisition module 200 may use measurement values of an acceleration sensor to calculate the definition. When a video is taken by using a device with an acceleration sensor, such as a smartphone, the video receiver module 100 may receive and store measurement values of the acceleration sensor along with the target video. The video receiver module 100 may receive and store acceleration values of camera movements in correspondence with times of the target video. As the velocity is obtainable by integrating the acceleration, the definition acquisition module 200 may calculate the speed of the camera and identify that the video has been taken in a stationary state when the speed is close to 0. The definition acquisition module 200 may determine that the lower the speed of the camera is, the higher the definition of the image frame of the target video at the corresponding view point is. Similarly, the measurement values of an angular speed sensor may be used. When a video is taken by a device with an angular speed sensor, a receiver module may receive and store measurement values of the angular speed sensor along with the target video. The definition acquisition module 200 may determine that the lower the absolute value of the angular velocity is, the higher the definition of the image frame of the target video at the corresponding view point is. The definition acquisition module 200 may use both of the aforementioned acceleration and angular speed in combination, or use one of the two values to calculate the definition.

Third, the definition acquisition module 200 may use a method such as computer vision or machine learning to calculate the definition of image frames of the target video.

The definition acquisition module 200 may combine and use the foregoing three methods of calculating a definition, or use one of the three methods to calculate the definition. In some cases, a method other than the aforementioned methods may be used to calculate the definition of image frames.

In (b), the calculation result by the definition acquisition module 200 may be a quantitative value which may represent the definition in a relative number, or may be represented in a qualitative manner, such as good or bad to show whether the definition is higher or lower than a reference definition.

As described above, when the definition is calculated by the definition acquisition module 200, the definition storage module 300 may store the definition obtained in (b) in correspondence with the relevant image frame ((c); S300).

The definition storage module 300 performing (c) may store the definition of each image frame as a value corresponding to a serial number assigned to each image frame of the target video. In some cases, the definition storage module 300 may store each definition as a value corresponding to a time point on a time line of an image frame of the target video. The definition storage module 300 may use other methods to store the definition. In any cases, the definition storage module 300 may store the definition by using a method in which a definition corresponds to each image frame of the target video.

The process of calculating the definition by the definition acquisition module 200 described above may be performed with respect to every or some image frames of the target video. When the definition calculation is conducted only for some image frames, the definition may be calculated at a certain time interval or may be calculated with respect to a sampled image frame.

Once the definition of image frames of the target video is calculated, image frames having a definition higher than a certain reference definition may be extracted and used for various purposes. For example, the disclosure may be employed to perform simultaneous localization and mapping. By associating camera intrinsic parameters of a camera used to take the target video with high-definition image frames, a shape of a 3D object taken by the target video may be calculated. As only the clear image frames without a decrease in definition that may be caused by quick movement of a camera when taking a video (i.e., without blurriness) are used for calculation, more accurate 3D shape may be obtained. As such, by using the method of extracting only high-definition images among image frames of the target video, numbers of photo images may be obtained more quickly while securing a definition higher than a certain reference definition, compared to the case where images are taken one by one.

Hereinafter, the image which has a calculated definition higher than a predetermined reference definition, and thus is considered as a clear image as described above, is referred to as a selected image frame in embodiments below. The degree of reference definition may be predetermined to be a proper value according to a use and purpose of application of the disclosure.

The display module 400 may display the target video and/or the selected image frame on the display device 610 by various methods ((d); S400). Numerous methods may be used by the display module 400 to display the target video and the selected image frame on the display device 610 according to a purpose and use of a service.

The display module 400 may divide a screen area of the display device 610 and display the target video and the selected image frame in each separate area, or display the target video and the selected image frame in the same screen area in an overlapping or intersecting manner.

In addition, the display module 400 may display a 360 VR video generated by using the target video on the display device 610.

Hereinafter, application of the method of providing a high-definition photo service using a video image frame described in the disclosure to a service providing a 360 VR video is described.

In such case, a VR module 500 may use the image frames of the target video which are stored in (a) to perform a process of generating a 360 VR image (omni-directional image) ((e); S510). The VR module 500 may use various methods to generate a 360 VR image. The VR module 500 may generate a 360 VR image by combining image frames of the filmed target video which are projected on a screen in a hemi-sphere shape. The VR module 500 may properly convert the image frames of the target video taken in a general tetragonal photo shape to generate a 360 VR image.

The display module 400 may display the 360 VR image generated by the VR module 500 on the display device 610 ((f); S520).

As such, when a 360 VR image or a 360 VR video is displayed on the display device 610, a user may adjust a position and a direction and reduce or enlarge the displayed image of video by using an input device 620 to display a desired area on the display device 610. Accordingly, in (f), only a part of the 360 VR image generated by the VR module 500 may be displayed on the display device 610.

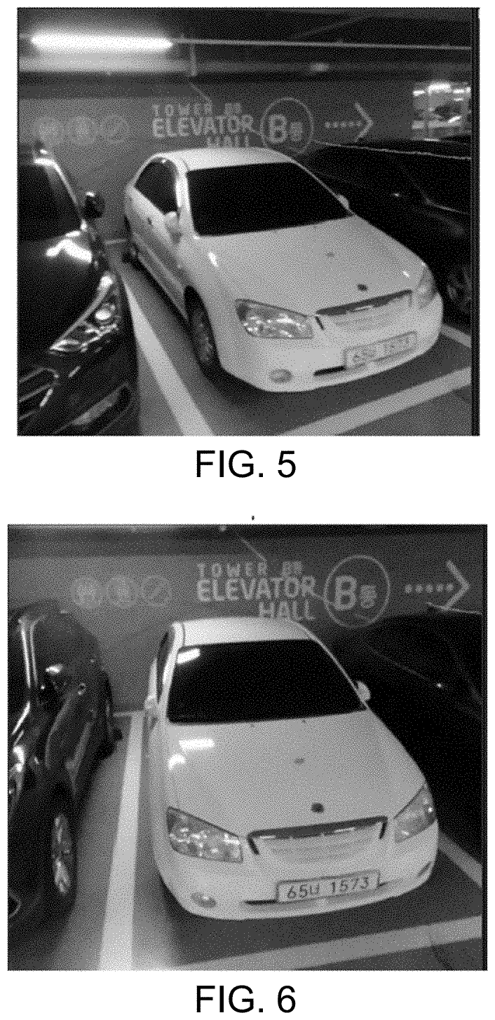

At this time, blurriness may exist in the image displayed on the screen of the display device 610 according to (f), and thus, the screen may not be shown clearly as illustrated in FIG. 5. In FIG. 5, the number plate of the vehicle may not be identified due to the low definition.

In this case, in (d), a selected image frame sharing at least a part of an area of the 360 VR image displayed on the display device 610 according to (f) may be displayed on the display device 610, which enables identification of the number plate of the vehicle as illustrated in FIG. 6.

As such, various methods may be used as necessary for the process of displaying a selected image frame according to (d). A selected image frame corresponding to the current 360 VR image may be displayed on a separate area of the screen, and an area of the display device 610 on which the current 360 VR image is displayed may be replaced with a selected image frame according to the user command. When a user inputs a command to display a selected image frame by using the input device 620 such as a mouse, the selected image frame may be displayed according to (d), and when the user does not adjust a position and a direction of a 360 VR image within a certain time period (e.g., 5 seconds), the display module 400 may automatically display a corresponding selected image frame according to (d).

The display module 400 may perform (d) by displaying on the display device 610 a selected image frame including an area most adjacent to an area of the 360 VR image displayed on the display device 610 according to (f) by the display module 400.

In some cases, the display module 400 may perform (d) by displaying on the display device 610 a selected image frame having a view point and a direction which are closest to a view point and a direction of the 360 VR image displayed on the display device 610 according to (f) by the display module 400.

By using the foregoing methods, both of a rough shape and a specific shape of a space or an object filmed by the target video may be easily identified. By displaying a general 360 VR video on the display device 610 according to (f), an overall shape or a rough shape of a filmed space or object may be identified. When there is a need to identify a specific shape or an exact form of an area, a user may check a selected image frame by performing (d).

As described above, in addition to the case where a video is displayed on the display device 610 in a 360 VR video format, when a general video is played in the same format as used in filming the video, the method of providing a high-definition photo service using a video image frame according to the disclosure may be used.

According to the method of providing a high-definition photo service using a video image frame of the embodiment, the target video stored by the video receiver module 100 in (a) may be displayed on the display device 610 by the display module 400 and then played ((g); S610), where (g) may be performed by a general video play application or by online streaming.

When performing (g), the display device 610 may display a time flow in a shape of a scroll bar on the display device 610.

In correspondence with the displayed scroll bar, the display module 400 may display the definition obtained in (b) with respect to each image frame of the target video ((h); S620).

The display module 400 may perform (h) by displaying the definition of the image frames corresponding to a time axis of the scroll bar in a graph, or displaying the definition of the image frames of the target video according to time flow by color changes. That is, in (h), the display module 400 may display the definition on the display device 610 in a manner that a user may visually identify a definition of an image frame at each time point in correspondence with the scroll bar visually representing times of the target video. The display module 400 may display changes in definition according to time flow as a high or low level in a graph, or in a color band which shows changes in definition according to time flow as color changes (e.g., a high definition is shown in blue, and a low definition is shown in red) or as brightness changes.

During when the target video is played, a user may intuitively identify the definition of the image frames constituting the target video through the graph of definition or the color band displayed in correspondence with the scroll bar. The user may watch a clear video by adjusting the scroll bar to a position where a selected image frame is displayed, based on the graph of definition or the color bad. Moreover, when a low-definition image frame is shown as illustrated in FIG. 5 while the user is watching the target video, the user may check a similar image frame which is time-sequentially adjacent to the low-definition image frame by referring to the definition displayed according to (h). That is, when a low-definition image is displayed on the screen, the play time point of the video may be adjusted to a time point at which a high-definition image frame before or after the low-definition image is displayed. As it is highly likely that same objects or spaces are shown in time-sequentially adjacent image frames, by checking a high-definition image frame among such adjacent image frames, a specific object, such as a number plate, a person, a space, etc. may be easily identified as illustrated in FIG. 6. Moreover, a user may visually identify the definition distribution of the target video quickly which allows easy, fast, and intuitive selection of a high-definition part of the video to watch.

As such, according to the disclosure, not only a large amount of image information may be obtained quickly and effectively by taking a video, but also the technical advantages obtainable by taking a photo may be achieved by separately extracting and using high-definition image frames among image frames included in a video.

The disclosure may also be used in taking a video for the purpose of managing a definition of image frames.

For example, when a user takes a video, the definition of image frames may be identified by various methods described above, and the definition of the video which is being taken by the user may be notified to the user in real time. When the definition of the video which is being taken by the user becomes lower, a warning sound may be output, or a low-definition state may be displayed on a screen of an imaging device. On the contrary, a sound may be output or a sign may be displayed on the display device 610 to indicate that the video is being taken at a definition high than or equal to a predetermined reference definition. As such, by noticing the definition in real time and taking a video of an area or an important object that require further identification at a sufficient definition, a user may use the video effectively for various purposes using image frames.

Even when the definition is not displayed in real time according to the foregoing, a user may move a camera at a relatively low speed when taking a video of an area which requires further identification to obtain high-definition image frames.

The aforementioned method of providing various services based on the definition of images frames of a video according to the disclosure is not limited to a 360° VR video, and may be applied to every types of videos. For example, in measuring a 3D distance by using 2D photo images or implementing a 3D model, high-definition image frames may be extracted from a video and used instead of photos.

Moreover, although the method of providing a high-definition photo service using a video image frame is described as including (e) and (f) in which a 360 VR image is generated and displayed on the display device 610, the method of providing a high-definition photo service using a video image frame may be performed without (e) and (f).

In addition, when a 360 VR image is generated according to (e) and then is displayed on the display device 610 according to (f), (b) describes that the definition acquisition module 200 obtains the definition of the image frame of the target video, and (c) and (d) are performed by using the obtained definition. However, in some cases, the method of providing a high-definition photo service using a video image frame may be performed by first generating a 360 VR image according to (e), and then calculating the definition by using the 360 VR image in (b), followed by (c) and (d) conducted by using the calculated definition. In this case, in (c), the definition of the 360 VR image may be stored instead of that of the image frame of the target video, and in (d), a high-definition 360 VR image among 360 VR images may be displayed on the display device 610 as a selected image frame. Also, in (d), displaying on the display device 610 the selected image frame corresponding to the 360 VR image displayed on the display device 610 in (f) is as described in the aforementioned embodiments.

In addition, although the case where the method of providing a high-definition photo service using a video image frame includes (g) and (h) in which the target video is played and the definition is displayed in correspondence with a scroll bar is described, the method of providing a high-definition photo service using a video image frame may be performed without (g) and (h), and even when (g) and (h) are conducted, the definition may be displayed and used along with the video by using a component similar to the scroll bar.

According to the method of providing a high-definition photo service using a video image frame, not only a large amount of image information may be obtained quickly and effectively by taking a video, but also the technical advantage in definition obtainable by taking a photo may be achieved by separately extracting and using image frames having a definition higher than a certain reference definition, among image frames included in the video.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of providing a high-definition photo service using a video image frame, the method comprising:
(a) receiving and storing, by a video receiver module, a target video taken in video format;
(b) obtaining, by a definition acquisition module, a definition for at least some image frames among image frames constituting the target video;
(c) storing, by a definition storage module, the definition obtained in (b) to correspond to an image frame; and
(d) displaying, by a display module, at least one of selected image frames, which are image frames having the definition stored in (c) that is higher than a reference definition, on a display device.

2. The method of claim 1, wherein,
in (b), the definition acquisition module compares image frames of the target video, which are adjacent to each other according to time flow, and determines that an image frame having less changes from adjacent image frames has a higher definition.

3. The method of claim 1, wherein,
in (b), the definition acquisition module calculates and obtains the definition by using a computer vision method or a machine-learning method.

4. The method of claim 1, wherein,
in (a), the video receiver module receives and stores a measurement value of an acceleration sensor according to time of a camera which has taken the target video, along with the target video, and
in (b), the definition acquisition module obtains the definition by determining that the lower a speed of the camera calculated by using the measurement value of the acceleration sensor received by the video receiver module is, the higher a definition of an image frame of the target video at the corresponding view point is.

5. The method of claim 1, wherein,
in (a), the video receiver module receives and stores a measurement value of an angular speed sensor according to time of a camera which has taken the target video, along with the target video, and
in (b), the definition acquisition module obtains the definition by determining that the lower an absolute value of an angular velocity of the camera calculated by using the measurement value of the angular speed sensor received by the video receiver module is, the higher a definition of an image frame of the target video at the corresponding view point is.

6. The method of claim 1, wherein,
in (c), the definition storage module stores each definition as a value corresponding to a serial number of each image frame of the target video.

7. The method of claim 1, wherein,
in (c), the definition storage module stores each definition as a value corresponding to a time point on a time line of each image frame of the target video.

8. The method of claim 1, further comprising:
(e) generating a 360 virtual reality (VR) image, by a VR module, by using the image frames of the target video stored in (a); and
(f) displaying, by the display module, the 360 VR image generated in (e) on the display device.

9. The method of claim 8, wherein,
in (d), the display module displays on the display device the selected image frame of which at least a part overlaps with an area of the 360 VR image displayed on the display device in (f).

10. The method of claim 8, wherein,
in (d), the display module displays on the display device the selected image frame including an area most adjacent to an area of the 360 VR image displayed on the display device in (f).

11. The method of claim 8, wherein,
in (d), the display module displays on the display device the selected image frame having a view point and a direction which are respectively closest to a view point and a direction of the 360 VR image displayed on the display device in (f).

12. The method of claim 1, further comprising:
(g) displaying and playing, by the display module, the target video stored in (a) on the display device; and
(h) displaying, by the display module, the definition obtained in (b) on the display device in correspondence with a time scroll bar of the target video played by the display module on the display device in (g).

13. The method of claim 12, wherein,
in (h), the display module displays definitions of the image frames of the target video according to time flow in a graph on the display device.

14. The method of claim 12, wherein,
in (h), the display module displays definitions of the image frames of the target video according to time flow as a color change on the display device.

15. A method of providing a high-definition photo service using a video image frame, the method comprising:
(a) receiving and storing, by a video receiver module, a target video taken in video format;
(e) generating, by a VR module, a 360 virtual reality (VR) image by using image frames of the target video stored in (a);
(b) obtaining, by a definition acquisition module, a definition of the 360 VR image generated by the VR module in (e);
(c) storing, by a definition storage module, the definition obtained in (b) to correspond to the 360 VR image;
(f) displaying, by a display module, the 360 VR image generated in (e) on a display device; and
(d) displaying, by the display module, at least one of selected image frames, which are 360 VR images having the definition stored in (c) that is higher than a reference definition, on the display device.

16. The method of claim 15, wherein,
in (d), the display module displays on the display device the selected image frame of which at least a part overlaps with an area of the 360 VR image displayed on the display device in (f).

17. The method of claim 15, wherein,
in (d), the display module displays on the display device the selected image frame including an area most adjacent to an area of the 360 VR image displayed on the display device in (f).

18. The method of claim 15, wherein,
in (d), the display module displays on the display device the selected image frame having a view point and a direction which are respectively closest to a view point and a direction of the 360 VR image displayed on the display device in (f).
